(19) United States
(12) Patent Application Publication
(10) Pub. No.: US 2008/0059236 A1
(43) Pub. Date: Mar. 6, 2008

(54) Emergency medical information device

(76) Inventor: Joseph C. Cartier, Cary, NC (US)

Correspondence Address: COATS & BENNETT, PLLC, 1400 Crescent Green, Suite 300, Cary, NC, 27518, US

(21) Appl. No.: 11/468,804

(22) Filed: Aug. 31, 2006

(51) Int. Cl. G06F 19/00; G06F 3/00

(52) U.S. Cl. 705/3; 710/36

(57) ABSTRACT

Emergency medical information stored on a portable data storage device is automatically displayed on a computer when the device is mated to the computer. The portable data storage device emulates a CD-ROM drive to the computer, and includes memory partitioned into an emulated CD-ROM and a hidden data storage area that is not accessible by the operating system of the computer. Program instructions stored in an autorun.exe file on the emulated CD-ROM caused the computer to display emergency medical information associated with individual and the individual's photograph. The hidden data storage area is only accessible via a private Application Programming Interface (API). The program displaying emergency medical information may access the hidden data storage area following access control, such as entering a password or a biometric scan.

### BACKGROUND

The present invention relates generally to the field of portable electronics and in particular to a portable storage device automatically presenting emergency medical information when coupled to a computer.

Making emergency medical information available to emergency room personnel, Emergency Medical Technicians (EN tea), and other first responders, when an individual is unconscious or otherwise incapacitated, has long been a concern. A wide array of “dog tags,” bracelets, wallet cards, and other items inscribed with emergency medical information has been developed. Such devices are of limited value to medical personnel, primarily because the wearer or carrier of the device cannot be assumed to be the individual associated with the medical information. Accordingly, such devices are only useful in conveying “negative” information. For example, if a medical information device indicates that an individual is allergic to a particular antibiotic, medical personnel may administer a different antibiotic; there is no danger in this case to the individual if he or she is not in fact allergic to the first antibiotic. On the other hand, medical personnel may not, for example, administer blood based solely on the blood type reported on a medical information device; each individual must be typed before blood can be administered.

A photograph may be included on a medical information device, such as a wallet card, that allows medical personnel to verify that the information is indeed associated with the individual with a reasonably high confidence level. However, the inclusion of a photograph limits the number of substrates suitable for a medical information device. It additionally limits the options for carrying or wearing a medical information device. For the photograph to be large enough to be useful, the device is necessarily larger than what may be comfortably and unobtrusively worn as jewelry.

A popular device for carrying data, such as a personal calendar, e-mail address book, digital audio files, and the like, is a small, portable device containing flash memory that connects to a computer via a Universal Serial Bus (USB). These devices are known variously as flash drives, thumb drives, and USB drives, as device drivers in the interface circuitry commonly emulate disk drives in the flash memory. It is known in the art to dedicate such a flash drive to carrying emergency medical information, and to include an individual's photograph among the information displayed. However, to display the emergency medical information, a user (such as a first responder) must plug the flash drive into a computer, and then access information on the flash drive via a GUI interface or the like. That is, a file containing emergency medical information must be located, identified, and selected. Furthermore, the computer must include display software capable of recognizing the file type and rendering the emergency medical information (including a photograph) to the screen. Navigating computer files is not part of emergency medical training, and users may store medical information under different filenames, in different directories, and the like. The necessity of locating and actively displaying emergency medical information stored on a flash drive severely limits the practical utility of such devices.

Early versions of the Windows operating system were capable of automatically executing a final with the filename of autorun.XXX (where XXX is one of the filename extensions recognized by Windows as being executable) whenever a new media containing such a file was discovered. This capability disappeared with the release of Windows XP. In Windows XP (and likely future versions of the operating system), the file autorun.XXX is only detected and executed when new media is detected in a CD-ROM drive. Accordingly, it is not possible to place an emergency medical information display program named autorun.exeXXX on a flash drive and have it automatically execute when the flash drive it is connected to a USB port of a computer.

### SUMMARY

According to one or more embodiments of the present invention, emergency medical information is automatically displayed on a computer in response to a portable data storage device being operatively mated to the computer. The portable data storage device emulates a CD-ROM drive to the computer, and includes memory partitioned into an emulated CD-ROM and a hidden data storage area that is not accessible by the operating system of the computer. Program instructions stored in an autorun.XXX file on the emulated CD-ROM caused the computer to display emergency medical information associated with individual and the individual's photograph. The hidden data storage area is only accessible via a private Application Programming Interface (API). The program displaying emergency medical information may access the hidden data storage area following access control, such as entering a password or a biometric scan.

In one embodiment, the present invention relates to a portable data storage device. The device includes a connector providing physical and electrical connectivity with a computer running an operating system and interface circuits providing data communications with the computer via the connector according to a standard protocol. The device additionally includes memory comprising an emulated CD ROM and a hidden data storage area not accessible by the computer operating system, and program instructions stored in the memory operative to automatically display emergency medical information associated with an individual on the computer upon the portable storage device being mated to the computer, and further operative to restrict access to the hidden data storage area. The device further includes a housing containing the interface circuits and memory.

In another embodiment, the present invention relates to a method of making emergency medical information available. Emergency medical information is entered into a portable data storage device operative to automatically display the emergency medical information upon being connected to a computer. The portable data storage device is then carried or worn.

In still another embodiment, the present invention relates to a method of maintaining patient medical records by a healthcare provider. A portable data storage device including memory comprising an emulated CD ROM and a hidden data storage area not accessible by a computer operating system is received from a patient. The portable data storage device is mated with a computer. The patient's identity is verified by comparison to a photograph of the patient that automatically displays on the computer's display in response to mating the portable data storage device with the computer. A healthcare provider account is accessed on the portable data storage device to access medical information stored on the device. Medical information is updated on the portable data storage device. The portable data storage device is removed from the computer and returned to the patient.

### BRIEF DESCRIPTION OF DRAWINGS

FIG. 1 is a perspective view of a portable data storage device.

FIG. 2 is a perspective view of a portable data storage device formed in an arcuate shape;

FIG. 3 is a perspective view of a portable data storage device having a biometric scanner;

FIG. 4 is a functional block diagram of a portable data storage device.

FIG. 5 is a representative emergency medical information display window.

FIG. 6 is a flow diagram of a method of medical information recordkeeping.

### DETAILED DESCRIPTION

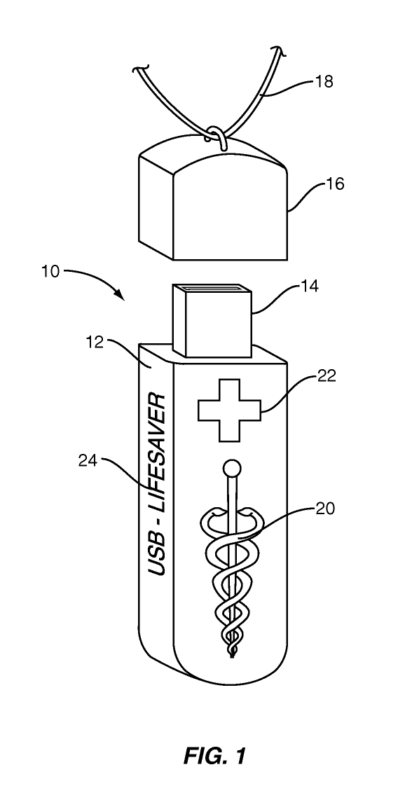

FIG. 1 depicts a portable data storage device 10 for automatically displaying emergency medical information, according to one or more embodiments of the present invention. The portable data storage device 10 includes a housing 12, USB connector 14, and a protective 16. The cap 16 fits over the USB connector 14, and protects the connector 14 from moisture, dust, and the like. The cap 16 “snaps” over the connector 14, mating with the housing 12 in a deformable or friction fit such that the cap 16 is not inadvertently dislodged due to incidental contact. In fact, the force required to remove the cap 16 from the housing 12 significantly exceeds the weight of the housing 12 and connector 14 together. Accordingly, the portable data storage device 10 may, in one embodiment, be suspended from the cap 16, which hangs from a chain 18. In this embodiment, the portable data storage device 10 may be worn as a necklace or the like.

In a preferred embodiment, indicia are formed on the housing 12 to indicate to first responders that the portable data storage device 10 contains emergency medical information. The indicia, for example, may comprise a medical insignia 20, such as a snake coiled around a staff, a first aid insignia 22, such as a red or white square cross, and/or any name or trademark 24 indicative of the nature of the portable data storage device 10. In addition, simple instructions may be provided on the housing 12.

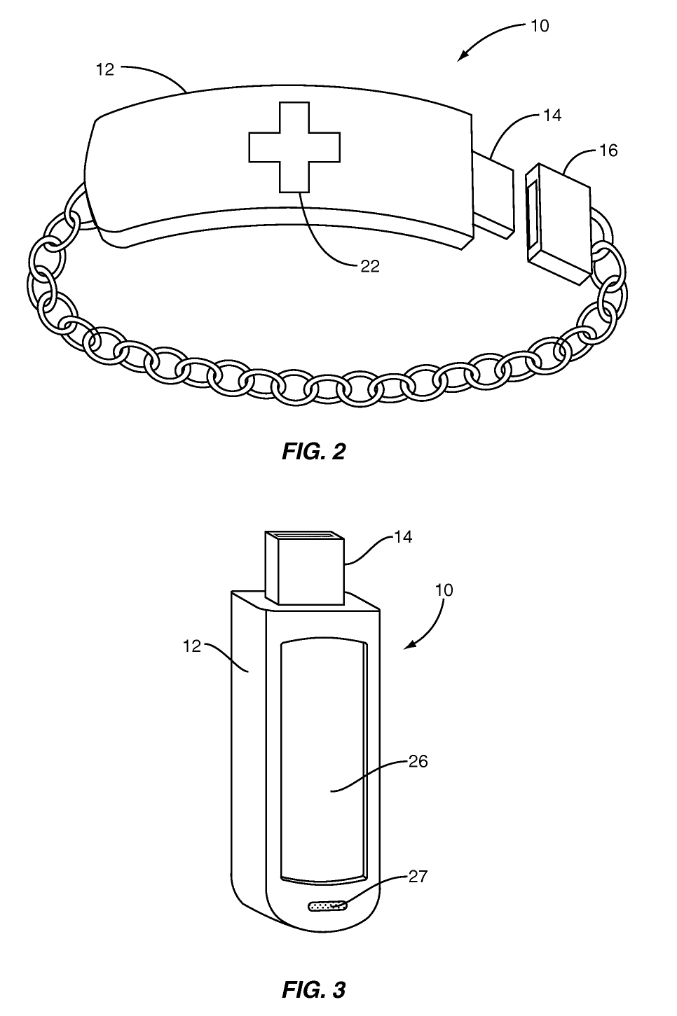

FIG. 2 depicts an embodiment wherein the housing 12 is formed in a curved or arcuate shape. A chain 23, or alternatively a strap, band, or the like, connects the housing 12 and the cap 16, allowing the portable data storage device 10 to be worn as a bracelet, anklet, or the like.

FIG. 3 depicts another embodiment of the portable data storage device 10 including a biometric scanner 26 such as a fingerprint scanner affixed to the housing 12, and operatively connected to control circuits within the housing 12. The fingerprint scanner 26 may comprise a capacitive sensor such as the Sony® FIU line of fingerprint scanners. Requiring a biometric scan increases the security of data stored in the portable data storage device 10, as described more fully herein. In one or more embodiments, a microphone 27, such as a condenser mic, is disposed within the housing 12. The microphone 27 may be used in conjunction with voice recognition software to free emergency medical personnel from the need to divert attention away from a patient to type commands into a computer with which the portable data storage device 10 is connected in operation.

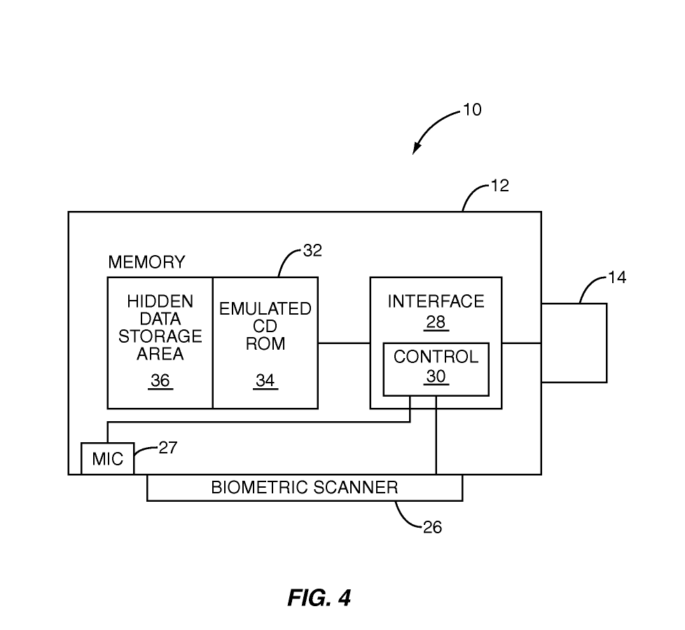

FIG. 4 depicts a functional block diagram of the portable data storage device 10. Within the housing 12 are interface circuits 28, including a controller 30, and flash memory 32. The memory 32 is partitioned into two areas: an emulated CD-ROM 34 and a hidden data storage area 36. The interface circuit 28 controls the USB interface, sending and receiving data to and from an attached computer according to the USB protocol. In some embodiments, the controller 30 receives signals from the biometric scanner 26 and/or microphone 27. These inputs may be processed locally (i.e. by the controller 30) or may be passed to the host computer for identification/verification and voice recognition, respectively.

The interface circuit 28 identifies itself to the computer via the USB protocol as a CD-ROM drive, and emulates a CD-ROM in one partition 34 of the memory 32. Since the operating system “sees” a CD-ROM drive, it will identify and execute an autorun.XXX file in the emulated CD-ROM partition 34 of the memory 32. Thus, when the portable data storage device 10 is inserted into a computer, the program in the autorun.XXX file is automatically executed. That is, no user input or selection is required to execute the program, once the portable data storage device 10 is inserted into the computer. All files stored on the CD-ROM are accessible to the operating system of the connected computer, just as if they were on an actual CD-ROM media in a CD-ROM drive.

The hidden data storage area 36 is not visible to the operating system of the attached computer. That is, no utility of the operating system, such as a File Explorer, or the File Open menu of an application program, can detect the hidden data storage area 36 at all, and hence is unable to display any file or folder stored thereon. The hidden data storage area 36 can only be accessed through a private Application Programming Interface (API). As known in the art, an API comprises a set of routines, protocols, and tools for building software applications. In particular, the private API of the present invention provides routines for reading and writing the hidden data storage area 36. The data storage access routines extant in APIs in other application programs, the operating system, BIOS, etc., are not aware of the hidden data storage area 36, and are not able to access it. Only customized software accessing the private API—such as a display program in an autorun.XXX file located on the emulated CD-ROM 34—can access files and folders in the hidden data storage area 36, through the private API.

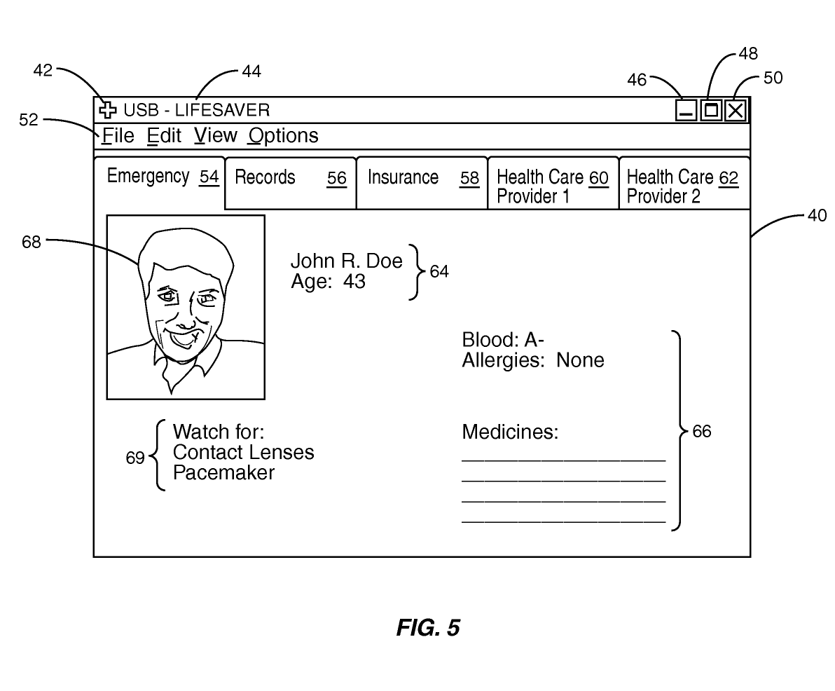

The autorun.XXX executes an emergency medical information display program that automatically displays an individual's photograph and emergency medical information related to the individual on a display device of the computer in which the portable data storage device 10 is inserted. FIG. 5 depicts a representative display screen 40 generated by the emergency medical information display program in the autorun.exe file. In one embodiment, the display screen 40 is a Windows GUI window, preferably maximized to cover essentially the entire display screen of the computer. As such, the window 40 includes common Windows features, such as a graphic icon 42 and textual identifier 44, and window manipulation buttons 46, 48, 50. The window 40 also displays a menu toolbar 52, wherein conventional control menus may be accessed. In one embodiment, the window 40 may present a “tabbed” display, wherein the main area of the window 40 changes depending on which tab 52, 54, 56 is selected.

In the default display, in which the window 40 is initially displayed upon inserting the portable data storage device 10 into the computer, the “Emergency” tab is selected, displaying a photograph 58; biographical information 60 such as name, age, telephone number, and the like; and emergency medical information 62, such as blood type, allergies, medications, and the like. Additionally, one or more warnings may be displayed, to alert medical personnel to the presence of contact lenses, a pacemaker, hearing aid, or the like. No confidential information, such as Social Security number, insurance policy numbers, or any medical history, is displayed on the Emergency tab. This prevents a breach of privacy, identity theft, or the like in the event that the portable data storage device 10 is lost or stolen.

Storing emergency medical information, and a photograph allowing for positive identification and verification that the associated medical information pertains to an individual, in a personal data storage device 10, and providing for the automatic display of the emergency medical information and photograph whenever the personal data storage device 10 is inserted into a computer, is a significant advance in the state of the art and has the potential to save thousands of lives by providing timely, accurate, richly detailed information to emergency medical personnel.

According to one or more embodiments of the present invention, the hidden data storage area 36 of the memory 32 is further utilized to provide a convenient, secure, accurate, and timely repository for all of an individual's medical records. For example, when a user selects, e.g., the Records tab 54 of the displayed window 40, a pop-up window appears, requesting identity verification prior to displaying the Records tab. In one embodiment, the user's identity may be verified by entering a password. In another embodiment, greater security is achieved by requiring the user to perform a biometric scan. A biometric scanner, such as a fingerprint scanner, may be attached to the computer into which the portable and storage device 10 is inserted. A biometric profile from this scanner may be transmitted via the USB interface to the portable data storage device 10, where it is verified by comparison to a stored biometric profile. Alternatively, in an embodiment of such as that depicted in FIGS. 3 and 5, where a biometric scanner 26 is attached to the housing 12 of the portable data storage device 10, the user may perform a biometric scan, such as a fingerprint scan, directly on the portable data storage device 10. As shown in FIG. 4, the biometric scanner 26 is operatively connected to a controller 30 that compares the scanned biometric profile to a stored biometric profile to verify the user's identity.

Once the user's identity has been verified, the user is granted access to medical records that are stored in the hidden data storage area 36 of the memory 32. The medical records may include any non-emergency medical information—that is, medical information that is not critical to emergency medical personnel in order to provide life-saving first aid and/or medical care—and preferably include an individual's entire medical history. Examples of non-emergency medical information that may be stored in the hidden data storage area 36 of a portable data storage device 10 include reports of doctors' examinations, surgeries, images such as x-rays, laboratory analyses of such as blood works, dental records, vision exam results, and the like. By providing for the convenient, secure, portable storage of an individual's entire medical records, the individual may visit any medical professional at any time in any location, and be able to offer a full, complete, and total picture of the individual's medical history, to ensure the most accurate and timely diagnosis, prognosis, and treatment. Furthermore, the risk of error stemming from incorrect medical history information or lack of sufficient information is virtually eliminated.

According to one embodiment of the present invention, the hidden data storage area 36 of the portable data storage device 10 may additionally assist healthcare providers in filing medical claims for patients. The Insurance tab 56, which is protected by a password and/or biometric scan as described above, may contain information regarding an individual's health care insurance policies, including approved network health care providers, policy exclusions and limitations, and form templates for filing medical claims. Utilizing both the Records and Insurance tabs 54, 56, the portable data storage device 10 may automate many aspects of medical records keeping.

In one embodiment, individual healthcare providers may have accounts on the portable data storage device 10, accessed by tabs 58, 60 in the display window 40. The healthcare provider may enter records—including physician notes, lab results, images such as x-rays, and the like—directly into the portable data storage device 10. These records may be annotated to indicate their origin by healthcare provider. The records are available to the patient, such as under the password-protected Records tab 54, but it may be hidden from view by other health-care providers having accounts on the personal data storage device 10, at the discretion of the patient. Access privileges and restricting access to files in data processing systems is well known in the computing arts, and not further explicated herein.

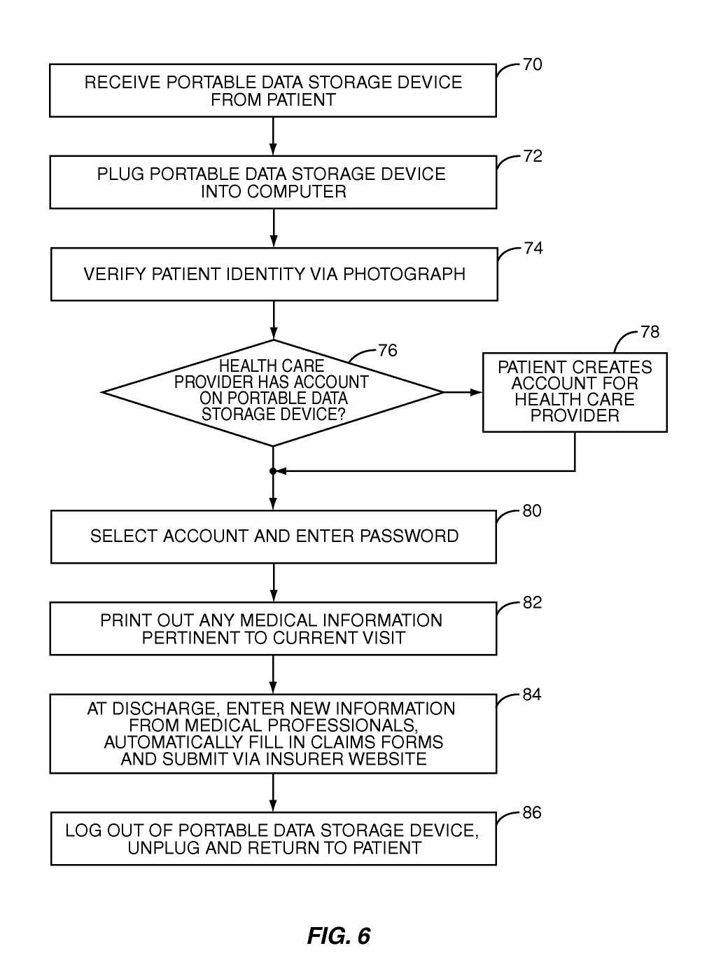

FIG. 6 depicts one method of medical information recordkeeping, performed by a healthcare provider, according to one embodiment of the present invention. A patient entering the healthcare provider would provide his or her portable data storage device 10 to the admissions personnel (block 70), who would plug the device 10 into a computer (block 72). The window 40 (FIG. 5) displaying the patient's photograph and emergency medical information will automatically appear on the computer's display. The admissions personnel may verify the patient's identity by viewing the displayed photograph (block 74).

If the healthcare provider has an account on the portable data storage device 10 (block 76), as may be indicated by a tab 58, 60 bearing the healthcare provider's name, the admissions personnel selects the account, and enters a password on the pop-up screen requesting such (block 80). If the healthcare provider does not have an account on the portable data storage device 10 (block 76), then the patient may create an account for the healthcare provider (block 78), such as via a utility accessed from a menu selection 50 (FIG. 5). Once the admissions personnel has access to the healthcare provider's account on the patient's portable data storage device 10, he or she may print out any recent medical information, or information that is otherwise pertinent to the current visit (block 82). The patient may designate information under the Records tab 54 as being selectively available to one or more—or all—healthcare providers having accounts on the portable data storage device 10. The admissions personnel may then return the portable data storage device 10 to the patient.

Following the patient's examination, consultation, or the like, the patient provides his or her portable data storage device 10 to the healthcare provider discharge personnel, to enter new medical information from the current visit, such as physician notes, medications prescribed, x-rays, or the like (block 84). The discharge personnel may additionally fill in insurance claim forms accessed via the Insurance tab 56. This ensures that the claims submission will precisely match both the substance and format required by the patient's insurer. In one embodiment, the discharge personnel may immediately file the claim by submitting the completed form to the insurer's web site (block 84). The discharge personnel logs out of the portable data storage device 10, unplugs it from a computer, and returns the portable data storage device 10 to the patient. As part of the logout procedure, a copy of all data entered into the personal data storage device 10 may be saved to the health care provider's computer system, to ensure that the medical information is not lost.

Health care information technology standards (e.g., Continuity of Care Record or CCR) are currently being developed to facilitate the transfer of this kind of information between Electronic Health Record (EHR) software applications. Currently, only approximately one third of US hospitals maintain health records electronically. The Certification Commission for Healthcare Information Technology (see cchit.org) is one body creating and promulgating EHR standards. The present invention implements these standards in order to interact with health care providers' computer systems.

In this manner, a patient's entire medical history may be conveniently and securely maintained, and provided to any medical professional as necessary. For example, if the patient is on a vacation or business trip, local medical personnel may access the patient's entire relevant medical history, without the need to transfer information from the patient's regular healthcare providers. Additionally, by integrating medical records storage and insurance claims form completion and submission, costly mistakes and delays in reimbursement by the insurer may be avoided.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A portable data storage device, comprising:
a connector providing physical and electrical connectivity with a computer running an operating system;
interface circuits providing data communications with the computer via the connector according to a standard protocol;
memory comprising an emulated CD ROM and a hidden data storage area not accessible by the computer operating system;
program instructions stored in the memory operative to automatically display emergency medical information associated with an individual on the computer upon the portable storage device being mated to the computer, and further operative to restrict access to the hidden data storage area; and
a housing containing the interface circuits and memory.

2. The portable storage device of claim 1 wherein the protocol is the Universal Serial Bus.

3. The portable storage device of claim 1 wherein the housing includes a medical indicia.

4. The portable storage device of claim 1 wherein the program instructions comprise an autorun.XXX file stored on the emulated CD ROM in the memory.

5. The portable storage device of claim 4 wherein the autorun.XXX file displays a photograph of the individual on the computer.

6. The portable storage device of claim 1 wherein the program instructions are further operative to selectively permit access to the hidden data storage area via a private Application Programming Interface (API).

7. The portable storage device of claim 6 wherein the program instructions permit access to the hidden data storage area only upon receiving and verifying a password.

8. The portable storage device of claim 6 wherein the program instructions permit access to the hidden data storage area only upon receiving and verifying a biometric property of the individual.

9. The portable storage device of claim 8 wherein the computer is operatively connected to a biometric scanner.

10. The portable storage device of claim 8 wherein the portable storage device further comprises a biometric scanner.

11. The portable storage device of claim 10 wherein the biometric scanner is a fingerprint scanner.

12. The portable storage device of claim 6 wherein the program instructions are operative to selectively read and write non-emergency medical information from and to the hidden data storage area via the private API.

13. The portable storage device of claim 12 wherein the program instructions are further operative to establish an account for a health care provider, and to restrict access to the account via a password.

14. The portable storage device of claim 12 wherein the program instructions are further operative to file health care claims with an insurer via a data communication network operatively connected to the computer.

15. The portable storage device of claim 1 wherein the portable storage device further comprises a microphone.

16. A method of making emergency medical information available, comprising:
entering emergency medical information into a portable data storage device operative to automatically display the emergency medical information upon being connected to a computer; and
carrying or wearing the portable data storage device.

17. The method of claim 16 further comprising:
connecting the portable data storage device to a computer; and
accessing, via a private Application Programming Interface (API), non-emergency medical data stored on the portable data storage device in a hidden data storage area not accessible by the operating system of the computer.

18. A method of maintaining patient medical records by a healthcare provider, comprising:
receiving from a patient a portable data storage device including memory comprising an emulated CD ROM and a hidden data storage area not accessible by a computer operating system;
mating the portable data storage device with a computer;
verifying the patient's identity by comparison to a photograph of the patient that automatically displays on the computer's display in response to mating the portable data storage device with the computer;
accessing a healthcare provider account on the portable data storage device to access medical information stored on the device;
updating medical information on the portable data storage device;
removing the portable data storage device from the computer; and
returning the portable data storage device to the patient.

19. The method of claim 18 wherein accessing a healthcare provider account on the portable data storage device comprises providing a password.

20. The method of claim 18 further comprising accessing insurance information on the portable data storage device.

21. The method of claim 20 further comprising filing in a claim form accessed on the portable data storage device.

22. The method of claim 21 further comprising electronically submitting the claim form by transmitting it to the insurer via a data communication network.
